(19) United States
(12) Patent Application Publication
(10) Pub. No.: US 2008/0196558 A1
(43) Pub. Date: Aug. 21, 2008

(54) Adjustable wrench with bearing guide device

(76) Inventor: John A. Picone, Oceanside, NY (US)

Correspondence Address: BERENATO, WHITE & STAVISH, LLC, 6550 ROCK SPRING DRIVE, SUITE 240, BETHESDA, MD, 20817, US

(21) Appl. No.: 12/068,655

(22) Filed: Feb. 8, 2008

Related U.S. Application Data
(60) Provisional application No. 60/900,090, filed on Feb. 8, 2007.
(60) Provisional application No. 60/907,510, filed on Apr. 5, 2007.

(51) Int. Cl. B25B 13/14; B25B 23/00

(52) U.S. Cl. 81/171; 81/165; 81/170

(57) ABSTRACT

An adjustable wrench comprising a head portion defining a stationary jaw and a mounting slot in the head portion extending in the direction of a transverse axis thereof, and a movable jaw member mounted to the head portion for reciprocating movement along the transverse axis. The movable jaw member includes a movable jaw in alignment with the stationary jaw and a gear rack having a toothed segment. The gear rack is slidably mounted in the mounting slot. The adjustable wrench further comprises a bearing guide device including at least two bearing guides disposed in a space between an outer wall of the gear rack and an inner wall of the mounting slot so that at least one of the bearing guides is arranged on one side of the gear rack and at least one of the bearing guides is arranged on the opposite side of the gear rack.

### CROSS-REFERENCE TO RELATED APPLICATION

This application relates to and claims priority under 35 U.S.C. 119(e) of U.S. Provisional Application Ser. No. 60/900,090, filed on Feb. 8, 2007 by John A. Picone, and U.S. Provisional Application Ser. No. 60/907,510, filed on Apr. 5, 2007 by John A. Picone, both of which are incorporated by reference herein.

### BACKGROUND OF THE INVENTION

1. Field of the Invention

The present invention relates generally to wrenches and, more particularly, to an adjustable wrench having a sliding adjustable jaw member.

2. Description of the Prior Art

A powered adjustable jaw wrench having a sliding jaw and a stationary jaw is known in the prior art. As illustrated in FIG. 1, the powered adjustable jaw wrench 10 of the prior art comprises a wrench body 11 including a wrench body member 12 provided with an integral stationary jaw 15, and a handle cover 16, a moveable jaw 17 adjustable relative to the stationary jaw 15. A handle portion 13 and a head portion 14 of the wrench body member 12 form a unitary single-piece part. A worm gear 19 and a sprocket 18 rotatable mounted in the head portion 14 of the wrench body member 12 coaxially with respect to each other. The worm gear 19 is operably connected to a toothed rack of the moveable jaw 17 so that the rotatable movement of the worm gear 19 is transformed into linear movement of the moveable jaw 17.

The prior art powered adjustable jaw wrench 10 further includes a drive mechanism: a motor 22, a sprocket 21, a drive belt 20, and control switch assembly 25, a switch actuator 26, and a power source 27 all housed in the unitary single-piece part wrench body member 12.

The moveable jaw 17 of the prior art, shown in FIG. 2 has a gear rack portion 31 including a tooth segment 32 and two non-toothed segments 33a and 33b at each distal end of toothed segment 32 respectively as preset stops, a jaw surface 30, a neck portion 34 and two slide rail surfaces 35a and 35b (fully shown better in FIG. 3A).

When operating the prior art powered adjustable jaw wrench 10 as shown in FIG. 3A the moveable jaw 17 tends to lean against reciprocal slot portions 23a and 23b due to the gap clearances between the two members located in wrench head frame 24. Specifically, the neck portion 34 of moveable jaw 17 rubs against the walls of slot portions 23a and 23b with gear rack 31 rubbing against walls of slot portions radius (cylindrical portion) 28 while moveable jaw slide surface 35a rubs on top of slide rail surface 36a of wrench head frame 24. This leaning and rubbing condition produces a wedging effect between the fit of moveable jaw 17 and said slot portions in the wrench head frame 24 causing undesirable friction which hampers the reciprocating movement of the sliding jaw.

Also, when operating the prior art powered adjustable jaw wrench 10 as shown in FIG. 3B the moveable jaw 17 has a tendency to rock back and fourth in radius slot 28 with moveable jaw 17 deflecting mostly in the direction away from the stationary jaw 15 due to gap clearances between the two members located in the wrench head frame 24. Specifically, the gear rack portion 31 of the moveable jaw 17 has an inherently loose fit condition with radius slot 28 in the wrench head frame 24. When the moveable jaw 17 is adjusted to grip a bolt and is used for tightening or loosening that bolt, the force of pressure is upon the moveable jaw 17 whereas, the moveable jaw 17 has a tendency to lift up and out of radius slot 28 in wrench head frame 24, tilting the face 30 of moveable jaw 17 in the direction away from the bolt and the stationary jaw 15, in turn, widening the adjustment grip and creating a gap between the moveable jaw and the bolt. The resultant “slippage” damages the bolt and a hand or body injury is also likely to occur.

Basically, the combination of a loose fit and weight of the sliding jaw being dragged through the slot portions in the wrench head frame in an unstable manner causes the excessive friction and added strain on the motor and drive train thus consuming more energy from the power source. The poor performance of the prior art powered adjustable wrench leads to undesirable effectivity of the grip and the moveable jaw adjustment. Prior art adjustable wrench specifications for manually adjustable wrenches are reliant on the workmanship clearances between the moveable jaw 17 and the head frame 24 as specified in ASME B107.8m and ISO 6786-1982. Unlike manually operated adjustable wrenches, powered adjustable wrenches have quicker traversing movements and operate by motors and batteries. Thus, to increase the overall performance of the powered adjustable wrench special clearances and physical improvements are necessary in the traverse area and the moveable jaw.

### SUMMARY OF THE INVENTION

The present invention is an improvement over the powered adjustable wrenches of the prior art disclosed in U.S. Pat. Nos. 4,512,221, 6,477,921, 6,966,242, and 7,114,824 incorporated herein by reference.

An adjustable wrench of the present invention comprises a wrench body including a wrench body member having a handle portion and a head portion, and a movable jaw member mounted to the head portion of the body member for reciprocating movement along a transverse axis of the head portion. The head portion defines a stationary jaw and a mounting slot in the head portion. The mounting slot has opposite first and second side walls extending in the direction of the transverse axis of the head portion and spaced from each other in the direction of a cross axis of the head portion perpendicular to the transverse axis thereof. The movable jaw member includes a movable jaw in alignment with the stationary jaw and a gear rack having a toothed segment. the gear rack is slidably mounted in the mounting slot.

The adjustable wrench of the present invention further comprises a bearing guide device disposed in the mounting slot and including at least two bearing guides disposed in a space between the gear rack and the mounting slot so that at least one of the at least two bearing guides is arranged on one side of the gear rack and at least one of the at least two bearing guides is arranged on the opposite side of the gear rack. The bearing guides replace a dimensional gap clearance defined by the space between the gear rack and the mounting slot for centering and guiding the gear rack in the mounting slot.

### BRIEF DESCRIPTION OF THE DRAWINGS

Other objects and advantages of the invention will become apparent from a study of the following specification when viewed in light of the accompanying drawings, wherein:

FIG. 1 is a perspective view showing a powered adjustable wrench of the prior art;

FIG. 2 is a side view of a moveable jaw of the powered adjustable wrench of the prior art;

FIG. 3A is a rear view of the powered adjustable wrench of the prior art;

FIG. 3B is a side view of the powered adjustable wrench of the prior art;

FIG. 4 is a perspective view of a powered adjustable wrench in accordance with a first exemplary embodiment of the present invention;

FIG. 5 is an exploded perspective view of a wrench body of the powered adjustable wrench in accordance with the first exemplary embodiment of the present invention;

FIG. 6 is an exploded perspective view of the wrench body of the powered adjustable wrench in accordance with the alternate embodiment of the present invention;

FIG. 7 is a schematic diagram of an electric circuitry for the powered adjustable wrench in accordance with the present invention

FIG. 8A is a side view of a moveable jaw member of the powered adjustable wrench in accordance with the first exemplary embodiment of the present invention;

FIG. 8B is a side view of an alternate moveable jaw member of the first exemplary embodiment of the powered adjustable wrench in accordance with the present invention;

FIG. 9 is a side view of the adjustable wrench showing the moveable jaw member mounted in a wrench head portion in accordance with the first exemplary embodiment of the present invention;

FIG. 10 is a partial front view of the adjustable wrench of the first exemplary embodiment showing the moveable jaw member mounted in a wrench body member in accordance with the present invention;

FIG. 11 is a partial perspective view of a head portion of the wrench body member in accordance with the first exemplary embodiment of the present invention;

FIG. 12 is a front view of the head portion of the wrench body member in accordance with the first exemplary embodiment of the present invention;

FIG. 13 is a front view of the moveable jaw member in accordance with the first exemplary embodiment of the present invention;

FIG. 14 is a side view of the moveable jaw member in accordance with the first exemplary embodiment of the present invention;

FIG. 15 is a partial view of the adjustable wrench showing the moveable jaw member mounted in the head portion of the wrench body member in accordance with the alternative embodiment of the present invention;

FIG. 16 is a partially exploded perspective view of the adjustable wrench in accordance with the further alternative embodiment of the present invention;

FIG. 17 is a side view of the moveable jaw member in accordance with the further alternative embodiment of the present invention;

FIG. 18 is a side view of the adjustable wrench of the further alternative embodiment showing the moveable jaw member mounted in a wrench head portion in accordance with the first exemplary embodiment of the present invention;

FIG. 19 is a partial front view of the adjustable wrench of the further alternative embodiment showing the moveable jaw member mounted in the wrench body member in accordance with the present invention;

FIG. 20 is a front view of the moveable jaw member in accordance with the further alternative embodiment of the present invention;

FIG. 21A is a side view of a moveable jaw member of the powered adjustable wrench in accordance with a second exemplary embodiment of the present invention;

FIG. 21B is a side view of an alternate moveable jaw member of the second exemplary embodiment of the powered adjustable wrench in accordance with the present invention;

FIG. 22 is a partial perspective view of a head portion of the wrench body member in accordance with the second exemplary embodiment of the present invention;

FIG. 23 is a partial front view of the adjustable wrench of the second exemplary embodiment showing the moveable jaw member mounted in the wrench body member in accordance with the present invention;

FIG. 24 is a front view of the head portion of the wrench body member in accordance with the second exemplary embodiment of the present invention;

FIG. 25 is a front view of the moveable jaw member in accordance with the second exemplary embodiment of the present invention;

FIG. 26 is an exploded perspective view of the wrench body of the powered adjustable wrench in accordance with the alternative embodiment of the present invention;

FIG. 27 is a partial perspective view of the head portion of the wrench body member in accordance with the alternative embodiment of the present invention;

FIG. 28 is a side view of the moveable jaw member of the second exemplary embodiment of the powered adjustable wrench showing the moveable jaw member mounted in the wrench body member in accordance with the alternative embodiment of the present invention;

FIG. 29 is a partial front view of the adjustable wrench of the alternative exemplary embodiment showing the moveable jaw member mounted in the wrench body member in accordance with the present invention;

FIG. 30 is a front view of the head portion of the wrench body member in accordance with the alternative embodiment of the present invention;

FIG. 31 is a side view of a moveable jaw member of the powered adjustable wrench in accordance with a third exemplary embodiment of the present invention;

FIG. 32 is a side view of the adjustable wrench showing the moveable jaw member mounted in the wrench head portion in accordance with the third exemplary embodiment of the present invention;

FIG. 33 is a partial front view of the adjustable wrench showing the moveable jaw member mounted in the wrench body member in accordance with the third exemplary embodiment of the present invention;

FIG. 34 is a side view of the moveable jaw member of the third exemplary embodiment of the powered adjustable wrench showing the moveable jaw member mounted in the wrench body member in accordance with the alternative embodiment of the present invention;

FIG. 35 is a partial front view of the adjustable wrench of the alternative exemplary embodiment showing the moveable jaw member mounted in the wrench body member in accordance with the present invention;

FIG. 36 is a side view of a moveable jaw member of the powered adjustable wrench in accordance with the further alternative embodiment of the present invention;

FIG. 37 is a side view of the adjustable wrench showing the moveable jaw member mounted in the wrench head portion in accordance with the further alternative embodiment of the present invention;

FIG. 38 is a partial front view of the adjustable wrench showing the moveable jaw member mounted in the wrench body member in accordance with the further alternative embodiment of the present invention.

### DETAILED DESCRIPTION OF PREFERRED EMBODIMENTS

The preferred embodiments of the present invention will now be described with the reference to accompanying drawings.

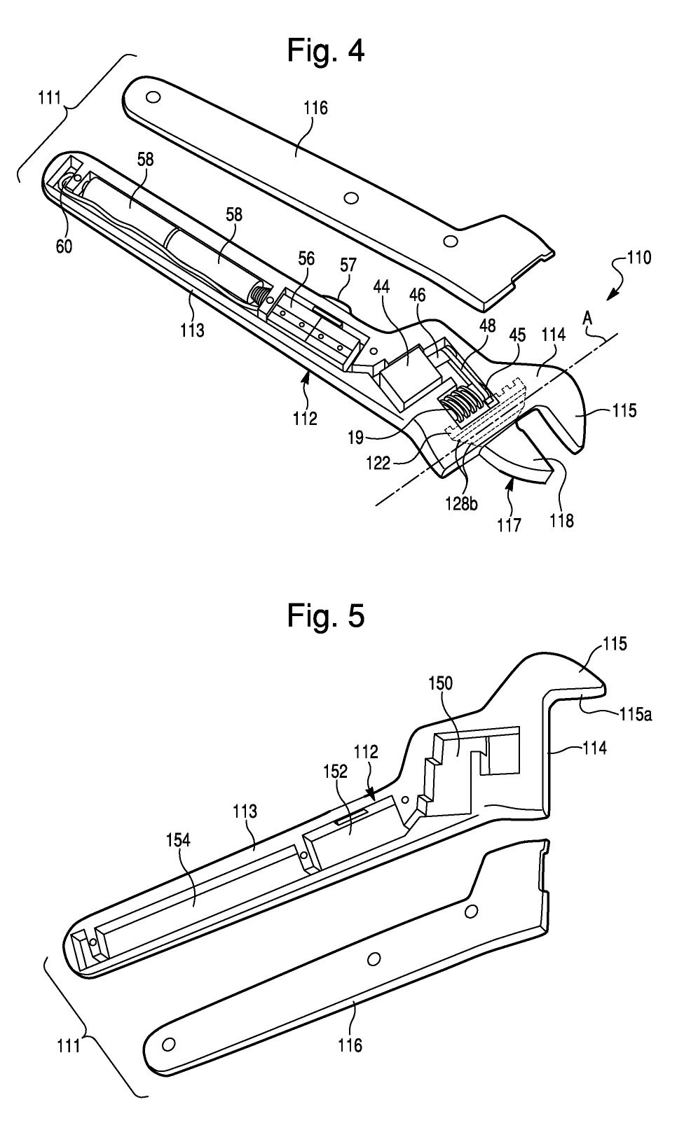

Referring now to FIG. 4, an improved powered adjustable wrench according to a first exemplary embodiment of the present invention is illustrated generally at 110 and comprises a wrench body 111 including a wrench body member 112, a handle cover 116 removably fastened to the wrench body member 112, and a moveable jaw member 117 slidably mounted to the wrench body member 112. Although the present invention is described in conjunction with the powered adjustable wrench, it will be appreciated that the present invention is equally applicable to a manually driven adjustable wrench.

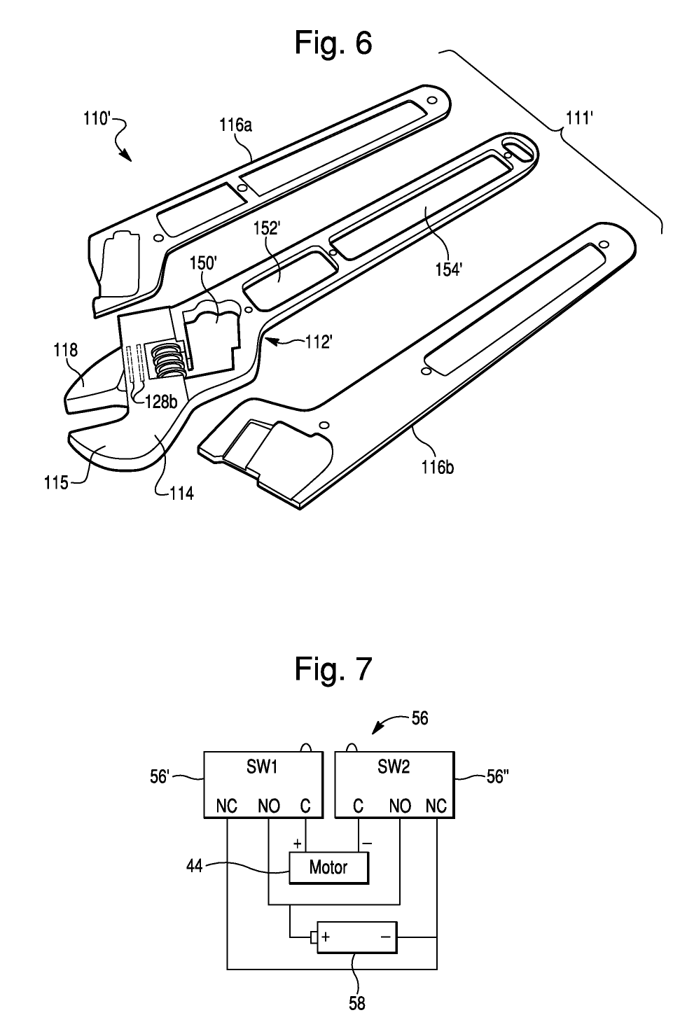

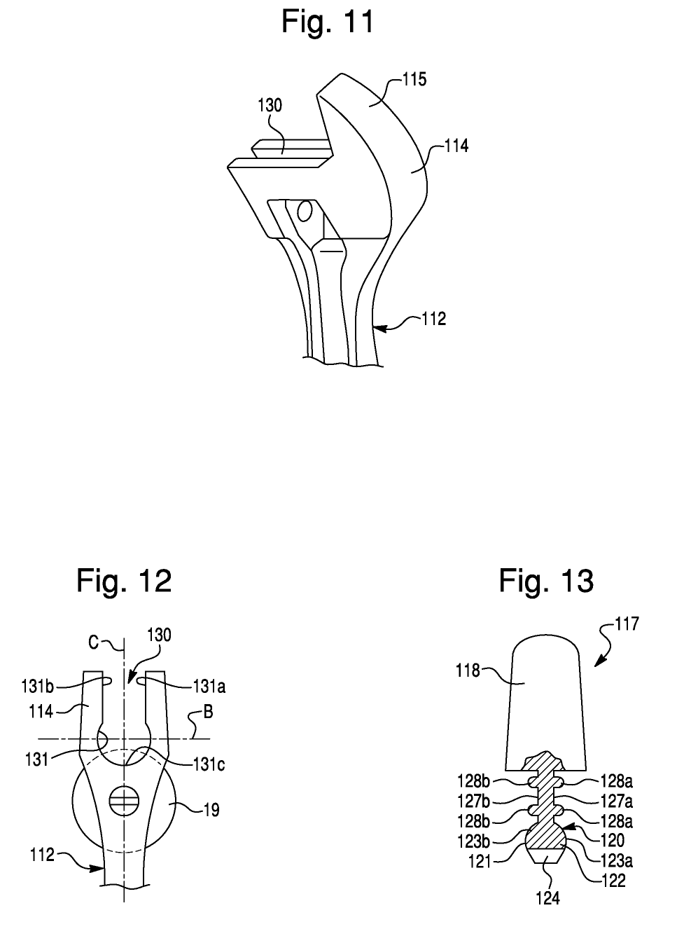

As illustrated in FIGS. 4 and 5, the wrench body member 112 includes a handle portion 113 and a head portion 114 defining a stationary jaw 115 integral to the head portion 114 and a mounting slot 130 in the head portion 114 (shown in FIGS. 10 and 11A) for slidably mounting the moveable jaw member 117 to the head portion 114 for reciprocating movement along a drive (or transverse) axis A of the head portion 114. The mounting slot 130 according to the present invention, as illustrated in detail in FIGS. 10, 11 and 12, is in the form of a U-shaped channel having an inner wall 131 including substantially flat, opposite first and second opposite side walls 131a and 131b, respectively, extending in the direction of the drive axis A of the head portion 124, interconnected by a substantially cylindrical bottom wall 131c also extending in the direction of the drive axis A. The opposite first and second side walls 131a and 131b of the mounting slot 130 are spaced from each other in the direction of a cross axis B of the head portion 114 (shown in FIG. 12). Preferably, the handle portion 113 and the head portion 114 of the wrench body member 112 form a unitary single-piece part. It will be appreciated by those skilled in the art that the wrench body member 112 may be made of any appropriate material such as metal (steel, aluminum, etc.) or plastic material. The metal wrench body member 112 may be manufactured, preferably, of stainless steel by forging. However, any other appropriate methods for manufacturing the wrench body member 112 made of metal, such as die-casting, investment casting, or punching from a metal plate, and are within the scope of the present invention. The plastic wrench body member is manufactured, preferably, by injection molding. However, any other appropriate methods for manufacturing the wrench body member 112 made of plastic material well known in the prior art, are within the scope of the present invention. According to the alternative embodiment of a powered adjustable wrench 110′ of the present invention, illustrated in FIG. 6, the wrench body 111′ includes a unitary single-piece wrench body member 112′ and a pair of opposite handle covers 116a and 116b removably fastened to the wrench body member 112′, preferably by bolts or screws.

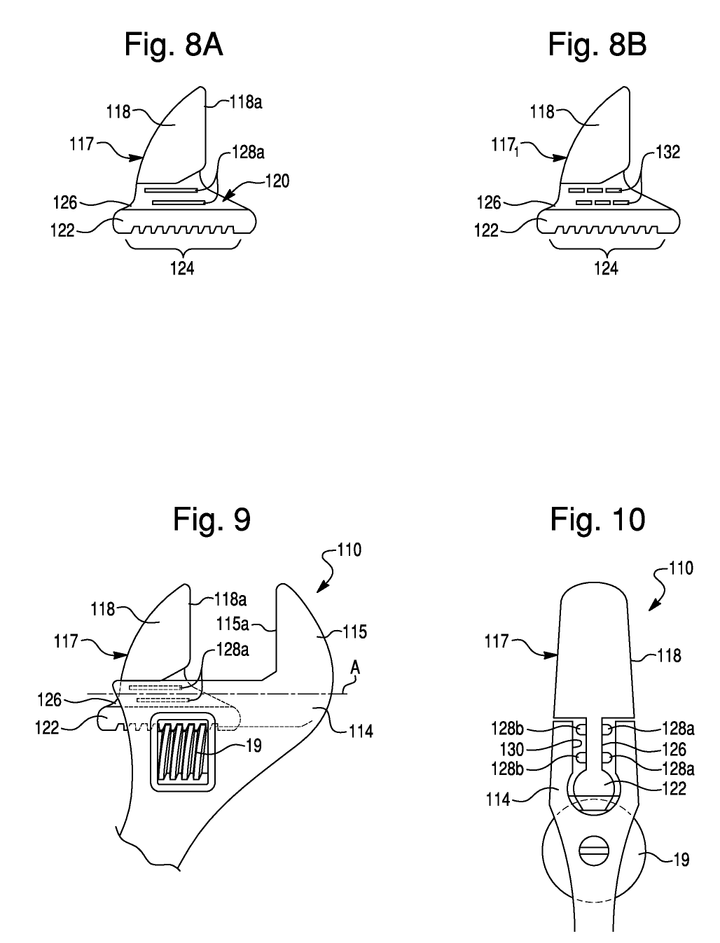

The movable jaw member 117, illustrated in detail in FIGS. 8A, 8B, 9, 10 and 13 is reciprocally mounted to the head portion 114 of the body member 112 and comprises a movable jaw 118 and a gear rack 120. It will be appreciated that the movable jaw 118 is reciprocally movable relative to the head portion 114 of the body member 112 along the drive axis A in alignment with the stationary jaw 115, as illustrated in FIGS. 4, 6 and 9. The movable jaw 118 has a jaw surface 118a (as shown in FIGS. 8A and 9) facing and in alignment with a jaw surface 115a of the stationary jaw 115 (as shown in FIGS. 5 and 9).

The gear rack 120, in turn, as illustrated in detail in FIGS. 8A, 10 and 13, gas an outer wall 121 and includes a substantially cylindrical gear rack portion 122 integrally formed with a toothed segment 124 on a truncated side of the cylindrical gear rack portion 122, and a reduced (narrow compared with the cylindrical gear rack portion 122) neck portion 126 interconnecting the movable jaw 118 with the gear rack portion 122. The cylindrical gear rack portion 122 has first and second opposite side walls 123a and 123b, respectively, and the neck portion 126 has opposite first and second opposite side walls 127a and 127b, respectively (as shown in FIG. 13). It should be understood that the outer wall 121 of the gear rack 120 includes the opposite first and second side walls 123a and 123b of the gear rack portion 122 and the opposite first and second side walls 127a and 127b of the neck portion 126.

As further illustrated in FIGS. 4, 6, 9 and 10, the gear rack 120 including the gear rack portion 122 and the neck portion 126 is disposed in the mounting slot 130 of the head portion 114 so that the gear rack portion 122 is enclosed within the cylindrical bottom wall 131c, while the neck portion 126 is disposed between the opposite side walls 131a and 131b of the mounting slot 130. More specifically, the first side wall 127a of the neck portion 126 faces the first side wall 131a of the mounting slot 130, while the second side wall 127b of the neck portion 126 faces the second side wall 131b of the mounting slot 130.

The moveable jaw member 117 may be manufactured of metal, preferably, of stainless steel by forging. However, any other appropriate methods for manufacturing the moveable jaw member 117 made of metal, such as die-casting, investment casting, or punching from a metal plate, and are within the scope of the present invention. The plastic moveable jaw member is manufactured, preferably, by injection molding. However, any other appropriate methods for manufacturing the moveable jaw made of plastic material well known in the prior art, are within the scope of the present invention.

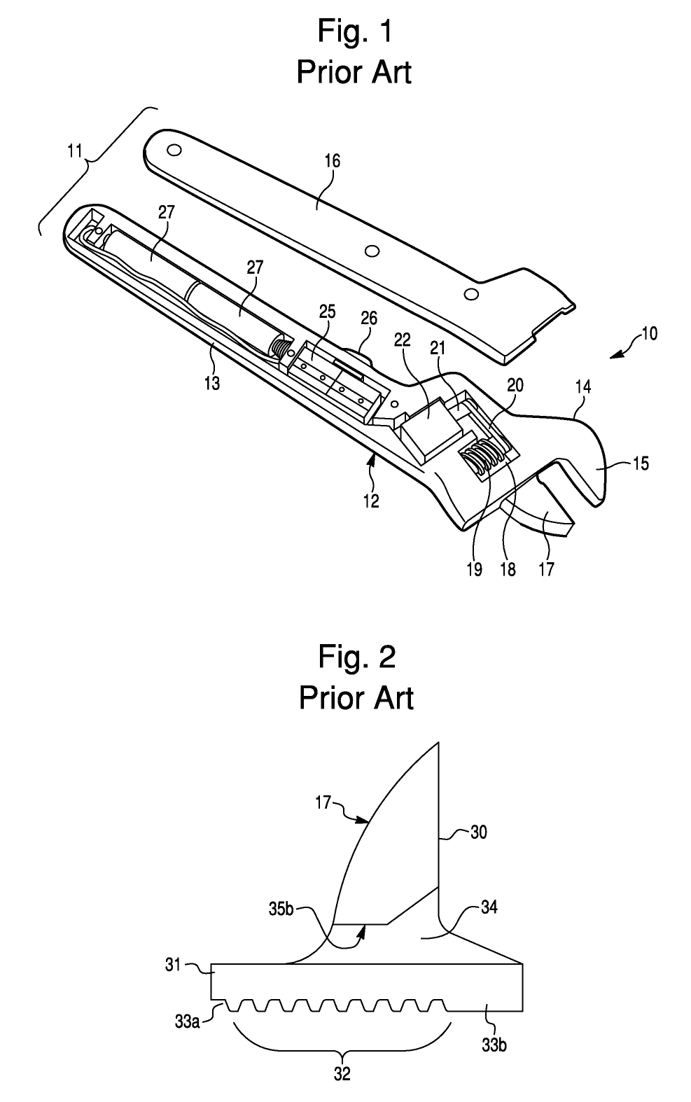

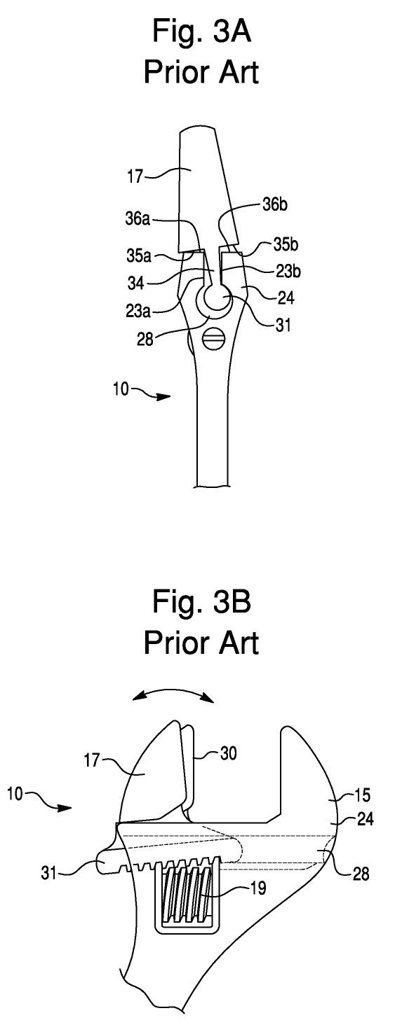

The powered adjustable wrench 110 according to the present invention further includes a drive mechanism substantially similar to the drive mechanism of the powered adjustable jaw wrench 10 illustrated in FIGS. 1, 2, 3A and 3B, which comprises a worm gear 16 rotatably mounted in the head portion 114 of the wrench body member 112, and a power source provided for rotating a worm gear 19. The worm gear 19 is drivingly connected to the toothed segment 124 of the gear rack portion 122 of the m movable jaw member 117 so that the rotatable movement of the worm gear 19 is transformed into the linear movement of the movable jaw member 117.

In accordance with the preferred embodiment of the present invention, illustrated in FIG. 4, the power source of the drive mechanism comprises a reversible electric motor 44 mounted in the handle portion 113 of the wrench body member 112. The reversible electric motor 44 is employed for rotating the worm gear 19 through an endless toothed belt 48. Alternatively, the drive mechanism may include an endless chain instead of belt for rotating the worm gear 19. It will be appreciated by those skilled in the art that any other type of an endless torque-transmitting element known in the prior art is within the scope of the present invention.

Alternatively, instead of the electric motor, a fluid-pressure motor, such as pneumatic or hydraulic motor, may be employed as the power source. Pressurized fluid, such as pressurized gas (e.g. air or carbon dioxide), could be supplied to the fluid-pressure motor from an external source of the pressurized fluid (not shown). A fluid flow control valve including a valve actuator, have to be provided to control direction of rotation of the fluid-pressure motor. Or, a pressurized gas cartridge, such as CO₂ cartridge, (not shown), or a rechargeable pressurized gas storage tank (not shown), mounted in the handle portion of the power wrench, may be utilized. Gas under pressure may be charged into the storage tank through the gas fitting by external sources of the compressed gas, such as a hand pump, compressor, charging tanks or cartridges. Further alternatively, the power wrench may include a fluid-pressure turbine as the power source.

As further illustrated in FIG. 4, the electric motor 44 is electrically connected to a control switch assembly 56 including a switch actuator 57, controlling the motor 44 and at least one electric battery 58 supplying electric power to the motor 44 and the control switch assembly 56. Preferably, two batteries 58 are provided. The batteries 58 may be rechargeable. In this case, a sub mini jack 60 is used for recharging the batteries 58. The electric motor 44, the control switch assembly 56 and the electric battery 58 are disposed in compartments 150, 152 and 154 respectively, formed in the handle portion 113 of the wrench body member 112, (as illustrated in FIG. 5.) The handle cover 113 is adapted to seal the compartments 150, 152 and 154.

The wrench body member 112′ in accordance with the alternative embodiment of FIG. 6, is provided with through openings 150′, 52′ and 54′ housing the electric motor 44, the control switch assembly 56 and the electric battery 58, respectively.

It will be appreciated that any appropriate type of electrical switches known in the prior art may be utilized in the present invention, such as a double pole double throw (DPDT) switch. Preferably, the control switch assembly 56 includes a pair of single pole double throw (SPDT) switches 56′ and 56″ and the switch actuator 57, as shown in FIG. 7.

The powered adjustable wrench 110 according to the present invention further comprises a bearing guide device provided to increase performance by stabilizing and reducing friction of the moveable jaw member 117. Specifically, the bearing guide device is provided to replace a gap clearance between contacting points of the gear rack 120 and the mounting slot 130 of the head portion 114 of the body member 112. Moreover, the bearing guide device minimizes the number of contact points between the gear rack 120 and the mounting slot 130 of the head portion 114, and is arranged between the gear rack 120 and the mounting slot 130 to offer maximum repeated stability and control for the reciprocating movement of the moveable jaw member 117. Preferably, the bearing guide device is disposed in the mounting slot 130 for centering and guiding the gear rack 120 of the moveable jaw member 117 in the mounting slot 130.

The bearing guide device according to the first exemplary embodiment of the present invention includes traverse bearing guides 128a and 128b as illustrated in detail in FIGS. 8A, 9, 10 and 13 that are integrally arranged on opposite sides of the neck portion 126 of the moveable jaw member 117 and extending in the direction of the drive axis A. Preferably, as shown in detail in FIGS. 10 and 13, the traverse bearing guides 128a and 128b are raised bosses formed as two domed (semi-cylindrically) shaped longitudinal ribs running along the length and arranged laterally on the neck portion 126 of the moveable jaw member 117. FIGS. 9 and 10 show the arrangement of the moveable jaw member 117 with the traverse bearing guides 128a and 128b as installed within the head portion 114 of the wrench body member 112, and whereas teeth of the toothed segment 124 of the gear rack portion 122 engage the worm gear 19.

The bearing guide device of the present invention includes at least two bearing guides 128a and 128b disposed in a space between the outer wall 121 of the gear rack 120 and the inner wall 131 of the mounting slot 130 (i.e. dimensional gap clearance) with at least one bearing guide 128a arranged on the first side wall 127a of the neck portion 126 of the gear rack 120 and at least one bearing guide 128b arranged on the second, opposite side wall 127b of the neck portion 126. The traverse bearing guides 128a and 128b extend outwardly (away from each other) from the first and second opposite side walls 127a and 127b in the direction of the cross axis B of the head portion 114 of the wrench body member 112 (shown in FIG. 12) and substantially perpendicular, or transverse, to the drive axis A. In other words, the traverse bearing guides 128a and 128b replace dimensional gap clearances between the first and second opposite side walls 131a and 131b of the mounting slot 130 and the first and second opposite side walls 127a and 127b of the gear rack 120. Preferably, as illustrated in detail in FIGS. 8A, 9, 10 and 13, the bearing guide device according to the first exemplary embodiment of the present invention includes two pairs of traverse bearing guides 128a and 128b: two bearing guides 128a arranged on the first side wall 127a of the neck portion 126 of the gear rack 120 and two bearing guides 128b arranged on the second, opposite side wall 127b of the neck portion 126. As illustrated in FIGS. 4, 9 and 10, the bearing guides 128a on the first side wall 127a of the neck portion 126 and the bearing guides 128b on the second side wall 127b are offset from each other in the direction of a longitudinal axis C of the head portion 114 of the wrench body member 112 (shown in FIG. 12). Preferably, the moveable jaw member 117 is formed integrally with the traverse bearing guides 128a and 128b as a single-piece part.

Those skilled in the art would appreciate that the bearing guides 128a and 128b according to the present invention increase performance of the powered adjustable wrench 110 by stabilizing and reducing friction of the moveable jaw member 117. The bearing guides 128a and 128b replace a dimensional gap clearance between contacting points of the gear rack 120 and the mounting slot 130 of the head portion 114 for centering and guiding the gear rack 120 of the moveable jaw member 117 in the mounting slot 130, and minimize the number of contact points between the gear rack 120 and the mounting slot 130 of the head portion 114 to offer maximum repeated stability and control for the reciprocating movement of the moveable jaw member 117. Furthermore, the present invention reduces the weight of the moveable jaw member 117 by decreasing the amount of material thereof as thickness of the neck portion 126 is lower that the thickness of the neck portion of the powered adjustable wrench 10 of the prior art shown in FIGS. 1, 2 and 3A.

According to the alternate embodiment of the moveable jaw member of the present invention generally depicted by the reference character 117₁ and illustrated in FIG. 8B, the bearing guide device includes a plurality of traverse bearing guides 132 in the form of raised bosses formed as short, domed shaped longitudinal ribs extending in the direction of the drive axis A that have interruptive alternating spaces separating the ribs from one after the other running along the length and arranged laterally on opposite side walls 127a and 127b of the neck portion 126 of the gear rack 120 of the moveable jaw member 117₁ (only the bearing guides 132 on the first side wall 127a of the neck portion 126 are shown on FIG. 8B). It will be appreciated that the traverse bearing guides 132 are substantially similarly formed on the opposite side 127b of the neck portion 126. The alternating spaces of the traverse bearing guides 132 on the neck portion 126 reduce weight and minimize the contact points for less friction of moveable jaw member 117₁. Further benefits of the alternating spaces provides clearances for any dirt or debris that could bind or hinder the performance of the moveable jaw member 117₁ traversing in the wrench head portion 114 of the wrench body member 112.

It will be appreciated that the present invention allows to selectively locate placement of the traverse bearing guides 128a and 128b to enhance the best performance of the moveable jaw member 117 and that the traverse bearing guides 128a and 128b can be formed into any and different bosses shapes, sizes, letters, variations and combinations thereof. An example of shape variations of the traverse bearing guides 128a and 128b include, but not limited to, round bosses, triangular bosses, square bosses, star shaped bosses (not shown), etc.

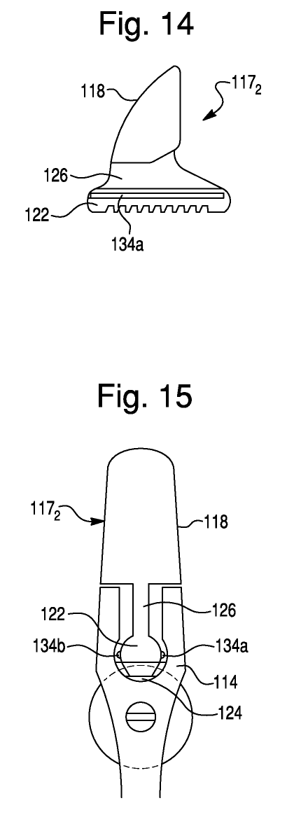

For instance, according to the alternative embodiment of the moveable jaw member of the present invention generally depicted by the reference character 117₂ and illustrated in FIGS. 14 and 15, the bearing guide device includes traverse bearing guides 134a and 134b are integrally arranged on the opposite first and second side walls 123a and 123b of the gear rack portion 122 of moveable jaw member 117₂. The traverse bearing guides 134a and 134b as shown in detail in FIGS. 14 and 15 are in the form of raised bosses formed as domed-shaped longitudinal ribs outwardly extending from opposite sides of the gear rack portion 122 in the direction of the cross axis B of the head portion 114 of the wrench body member 112 and substantially perpendicular, or transverse, to the drive axis A and running parallel along the length on the gear rack portion 122 of the moveable jaw member 117₂ in the direction of the drive axis A.

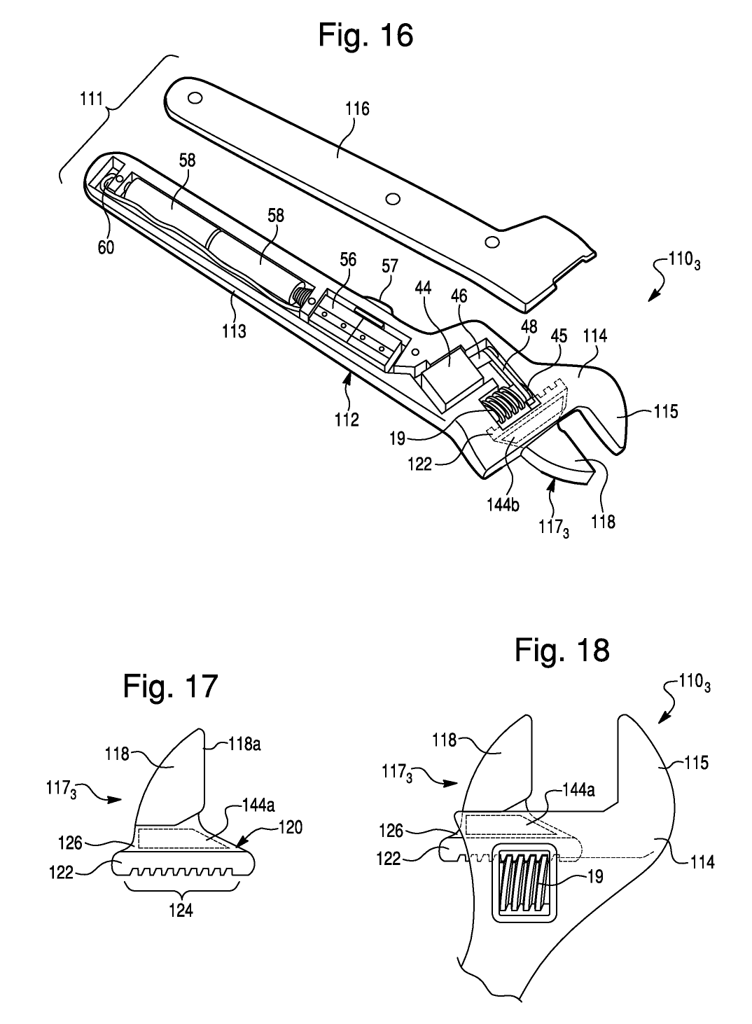

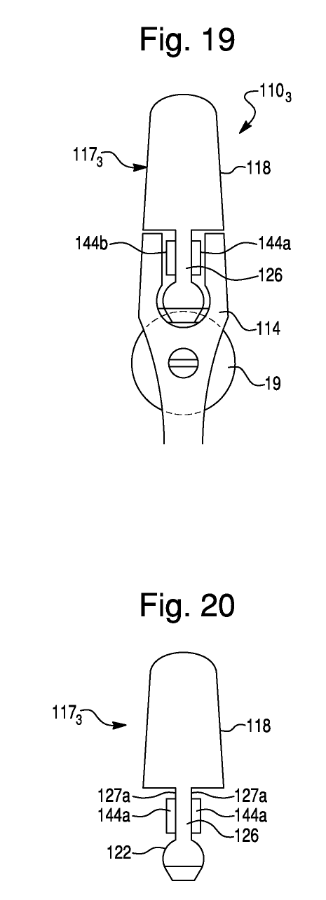

According to the further alternative embodiment of the powered adjustable wrench of the present invention generally depicted by the reference character 110₃ and illustrated in FIGS. 16-20, the bearing guide device of a moveable jaw member 117₃ includes traverse bearing guides 144a and 144b that are formed separately from the moveable jaw member 117₃ and then arranged on opposite sides of the reduced neck portion 126 of moveable jaw member 117₃, as illustrated in detail in FIG. 19. The traverse bearing guides 144a and 144b as shown in detail in FIGS. 19 and 20 are in the form of raised bosses formed as longitudinal prismatic ribs outwardly extending from opposite sides of the gear rack portion 122 in the direction of the cross axis B of the head portion 114 of the wrench body member 112 and substantially perpendicular, or transverse, to the drive axis A and running parallel along the length on the gear rack portion 122 of the moveable jaw member 117₃ in the direction of the drive axis A. Preferably, the traverse bearing guides 134a and 134b of the moveable jaw member 117₃ have rectangular cross-section (as shown in detail in FIGS. 19 and 20) or trapezoidal cross-section.

Further preferably, the traverse bearing guides 144a and 144b are two Teflon impregnated strips bonded to the metal of the reduced neck portion 126 of the moveable jaw member 117₃ by any suitable adhesive (such as a silicone adhesive) affixed longitudinally along the length of the reduced neck portion 126 of the moveable jaw member 117₃. It will be appreciated that Teflon is a fluorine-containing polymer or fluoropolymer, such as Teflon-PTEE (or Polytetrafluoroethylene). FIGS. 19 and 20 show the placement of the traverse bearing guides 144a and 144b affixed to the reduced neck portion 126 of the moveable jaw member 117₃. FIGS. 16, 18 and 19 show the arrangement of the moveable jaw 117₃ with the traverse bearing guides 144a and 144b as installed in the head portion 114 of the wrench body member 112, and whereas teeth 124 of the gear rack portion 122 engage the worm gear 19. The metal moveable jaw member 11173 may be manufactured, preferably, of stainless steel by forging. However, any other appropriate methods for manufacturing the moveable jaw member 11173 made of metal, such as die-casting, investment casting, or punching from a metal plate, and are within the scope of the present invention.

Those skilled in the art would appreciate that the present invention allows to selectively locating placement of the traverse bearing guides 144a and 144b to enhance the performance of the moveable jaw member and that the traverse bearing guides 144a and 144b can be easily affixed by either bonding methods with appropriate adhesives or applied by self-adhesive tapes. One skilled in the art appreciates that there are various types of “slick” coated strips and thicknesses to choose from that can be utilized as traverse guides that fall into the scope of the present invention. Successful implementation and tested by the inventor include, but not limited to, are UHMW (Ultra High Molecular Weight) Polyethylene with High Stick Acrylic Adhesive, Teflon Laminate Copper with High Temp Silicone Adhesive, High Density Skived PTFE (TEFLON) Tape with Silicone Adhesive.

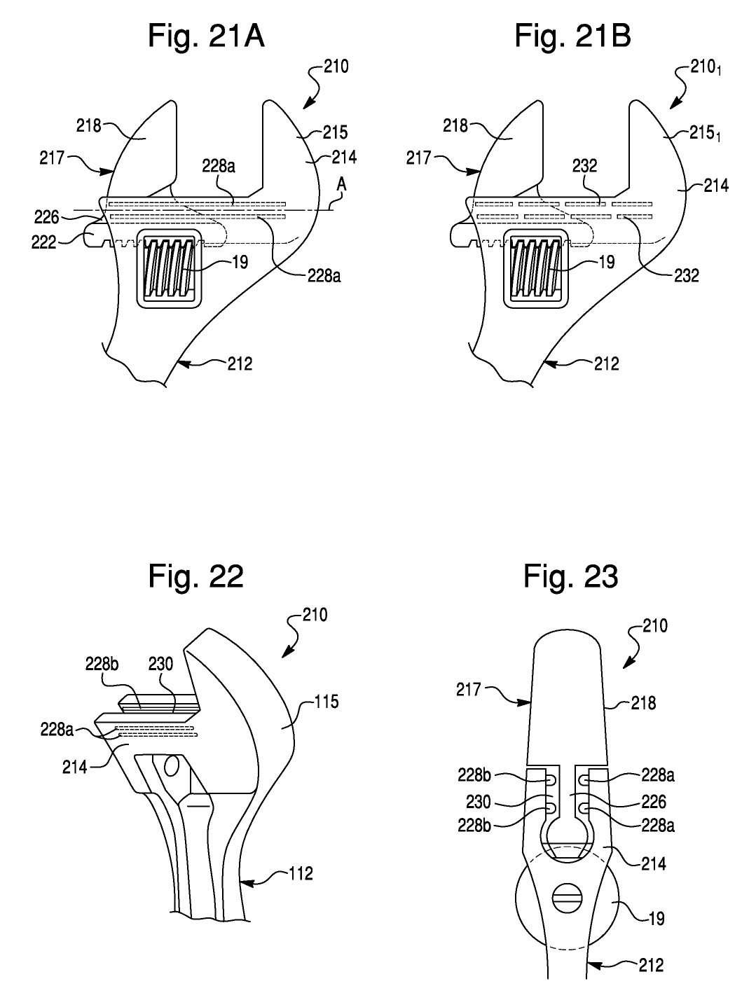

FIGS. 21A-25 illustrate a second exemplary embodiment of a powered adjustable wrench, generally depicted by the reference character 210. Components, which are unchanged from the previous exemplary embodiments of the present invention, are labeled with the same reference characters. Components, which function in the same way as in the first exemplary embodiment of the present invention depicted in FIGS. 4-20 are designated by the same reference numerals to which 100 has been added, sometimes without being described in detail since similarities between the corresponding parts in the two embodiments will be readily perceived by the reader.

The powered adjustable wrench of FIGS. 21A-25 corresponds substantially to the powered adjustable wrench of FIGS. 4-20, and only the portions of the moveable jaw member and the wrench head portion, which differ, will therefore be explained in detail below. Specifically, in accordance with the second exemplary embodiment of the present invention the bearing guide device of the present invention includes at least two traverse bearing guides 228a and 228b are located inside a traverse mounting slot 230 of a wrench head portion 214 and integrally with opposite side walls of the mounting slot 230 as shown in FIGS. 21A-25.

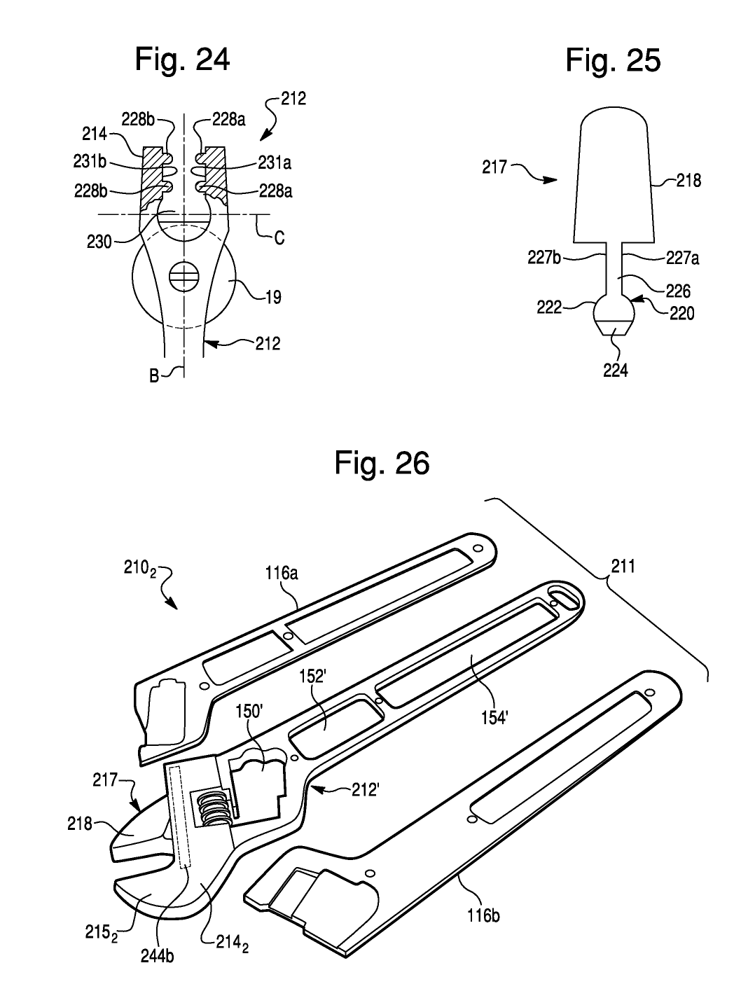

The mounting slot 230 according to the second exemplary embodiment of the present invention, as illustrated in detail in FIGS. 23 and 24, is in the form of a U-shaped channel having substantially flat, opposite first and second opposite side walls 231a and 231b, respectively, extending in the direction of the drive axis A of the head portion 214.

The traverse bearing guides 228a and 228b as illustrated in detail in FIG. 24 are integrally formed on the opposite side walls 231a and 231b, respectively, of the mounting slot 230 located within the wrench head portion 214. Preferably, the traverse bearing guides 228a and 228b are raised bosses formed as two domed (semi-cylindrically) shaped longitudinal ribs running along the length and arranged laterally on the opposite side walls 231a and 231b, respectively, of the mounting slot 230 located within the wrench head portion 214. As shown in FIGS. 23 and 24, the traverse bearing guides 228a and 228b extend inwardly (toward each other) from the opposite side walls 231a and 231b, respectively, of the mounting slot 230 in the direction of the cross axis B of the head portion 114 of the wrench body member 112 and substantially perpendicular, or transverse, to the drive axis A. FIGS. 21A and 23 show the arrangement of the moveable jaw member 217 as installed in the head portion 214 of the wrench body member 212. As illustrated in FIGS. 23 and 24, the bearing guides 228a on the first side wall 231a of the mounting slot 230 and the bearing guides 228b on the second side wall 231b are offset from each other in the direction of the longitudinal axis C of the head portion 214 of the wrench body member 212 (shown in FIG. 24). In other words, the traverse bearing guides 228a and 228b replace dimensional gap clearances between the first and second opposite side walls 231a and 231b of the mounting slot 230 and the first and second opposite side walls 227a and 227b of the gear rack 220.

Those skilled in the art would appreciate that the present invention for the moveable jaw member 217 of the second embodiment does not contain any traverse bearing guides at the reduced neck portion 226, thus further weight reducing benefits of the moveable jaw member 217 are achieved increasing the efficiency of the adjustable wrench 210.

According to the alternate embodiment of the moveable jaw member of the present invention generally depicted by the reference character 217, and illustrated in FIG. 21B, the bearing guide device includes a plurality of traverse bearing guides 232 in the form of raised bosses formed as short, domed shaped longitudinal ribs extending in the direction of the drive axis A that have interruptive alternating spaces separating the ribs from one after the other running along the length and arranged laterally on opposite side walls 231a and 231b of the mounting slot 230 of the wrench head portion 214 (only the bearing guides 232 on the first side wall 231a of the mounting slot 230 are shown on FIG. 21B). It will be appreciated that the traverse bearing guides 232 are substantially similarly formed on the opposite side 231b of the mounting slot 230. The alternating spaces of the traverse bearing guides 232 on the mounting slot 230 reduce weight and minimize the contact points for less friction of moveable jaw member 217₁. Further benefits of the alternating spaces provides clearances for any dirt or debris that could bind or hinder the performance of the moveable jaw member 217₁ traversing in the wrench head portion 214 of the wrench body member 212.

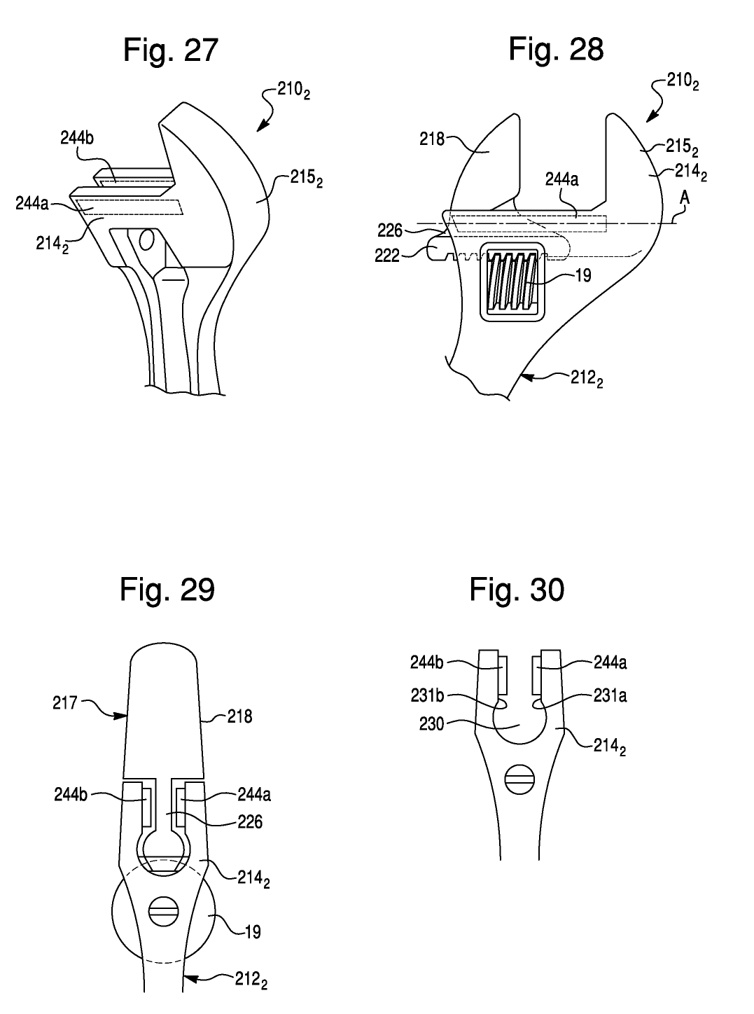

According to the further alternative embodiment of the powered adjustable wrench of the present invention generally depicted by the reference character 210₂ and illustrated in FIGS. 26-30, the bearing guide device includes traverse bearing guides 244a and 244b that are formed separately from a head portion 214₂ of a wrench body member 212₂ and are arranged on opposite side walls 231a and 231b of the mounting slot 230 in the direction substantially perpendicular, or transverse, to the drive axis A, as illustrated in detail in FIGS. 27-30. The traverse bearing guides 244a and 244b as shown in detail in FIGS. 29 and 30 are in the form of raised bosses formed as longitudinal prismatic ribs extending from opposite side walls 231a and 231b, respectively, of the mounting slot 230 located within the wrench head portion 214₂. As further shown in FIGS. 29 and 30, the traverse bearing guides 244a and 244b extend inwardly (toward each other) from the opposite side walls 231a and 231b, respectively, of the mounting slot 230 in the direction substantially perpendicular, or transverse, to the drive axis A. Preferably, the traverse bearing guides 244a and 244b are two Teflon impregnated strips bonded to the side walls 231a and 231b of the mounting slot 230 by any suitable adhesive (such as a silicone adhesive) affixed longitudinally along the length of the mounting slot 230 of the wrench head portion 214₂.

Those skilled in the art would appreciate that the present invention allows to selectively locating placement of the traverse bearing guides 244a and 244b to enhance the performance of the moveable jaw member 217 and that the traverse bearing guides 244a and 244b can be easily affixed by either bonding methods with appropriate adhesives or applied by self-adhesive tapes. One skilled in the art appreciates that there are various types of “slick” coated strips and thicknesses to choose from that can be utilized as traverse guides that fall into the scope of the present invention. Successful implementation and tested by the inventor include, but not limited to, are UHMW (Ultra High Molecular Weight) Polyethylene with High Stick Acrylic Adhesive, Teflon Laminate Copper with High Temp Silicone Adhesive, High Density Skived PTFE (TEFLON) Tape with Silicone Adhesive.

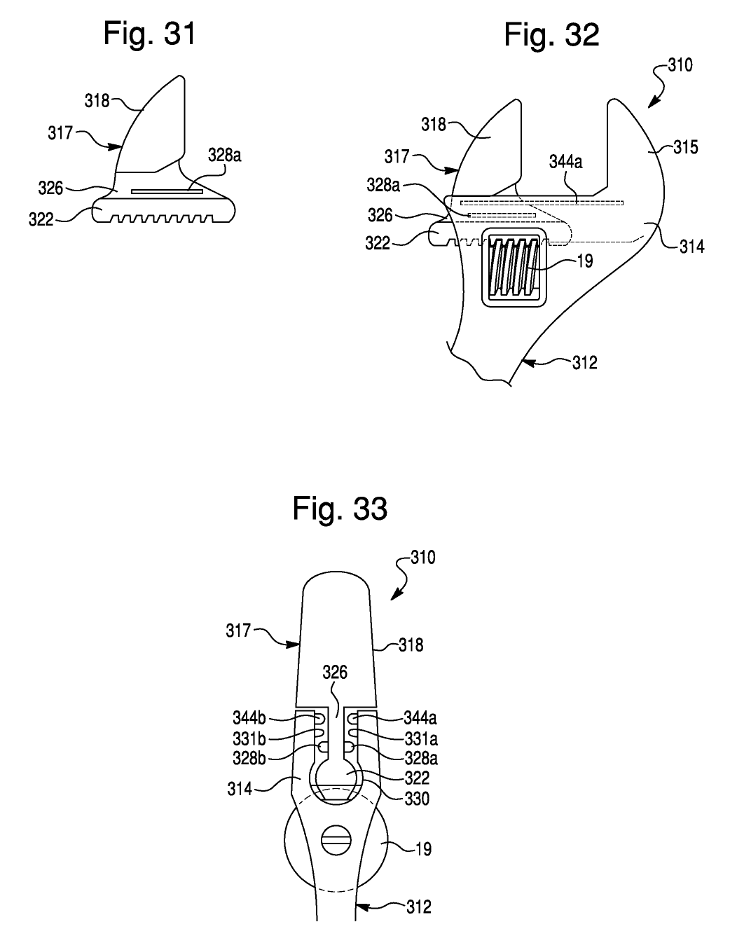

FIGS. 31-33 illustrate a third exemplary embodiment of a powered adjustable wrench, generally depicted by the reference character 310. Components, which are unchanged from the previous exemplary embodiments of the present invention, are labeled with the same reference characters. Components, which function in the same way as in the first exemplary embodiment of the present invention depicted in FIGS. 4-20 are designated by the same reference numerals to which 200 has been added, sometimes without being described in detail since similarities between the corresponding parts in the two embodiments will be readily perceived by the reader.

The adjustable wrench 310 of FIGS. 31-33 corresponds substantially to the powered adjustable wrench 110 of FIGS. 4-20, and only the portions of the moveable jaw member and the wrench head portion, which differ, will therefore be explained in detail below. Specifically, in accordance with the third exemplary embodiment of the present invention the bearing guide device of the present invention includes two traverse bearing guides 328a and 328b integrally formed on opposite sides of a neck portion 326 of a moveable jaw member 317 and extending in the direction of the drive axis A, and two traverse bearing guides 344a and 344b located inside a traverse mounting slot 330 of a wrench head portion 214 and formed integrally with opposite side walls of the mounting slot 330 as shown in FIG. 33.

As shown in detail in FIGS. 31 and 33, the traverse bearing guides 328a and 328b of moveable jaw member 317 are in the form of a raised boss formed as a domed shaped longitudinal rib running along the length of a reduced neck portion 326 of the moveable jaw member 317. FIGS. 32 and 33 show each of the traverse bearing guides 344a and 344b of the wrench head portion 314 is a raised boss formed as a domed shaped longitudinal rib running along the length of the inside of the mounting slot 330 of the wrench head portion 314. Now, when the moveable jaw member 317 is installed into wrench head portion 314 as shown in FIG. 33, the traverse bearing guides 344a and 344b of wrench head portion 314 act as guides and stops for the traverse bearing guides 328a and 328b of the moveable jaw member 317. As moveable jaw 174 traverses inside slot of wrench head frame 24, the traverse bearing guides 328a and 328b of the moveable jaw member 317 bump and slide underneath the traverse bearing guides 344a and 344b located in the mounting slot 330 in wrench head portion 314. The traverse bearing guides 344a and 344b of the wrench head portion 314 further act as stops that contain and secure the moveable jaw member 317 from pulling out of the wrench head portion 314 and also preventing the moveable jaw member 317 from rocking back and fourth in the mounting slot 330 of the wrench head portion 314 in the direction away from a stationary jaw 315.

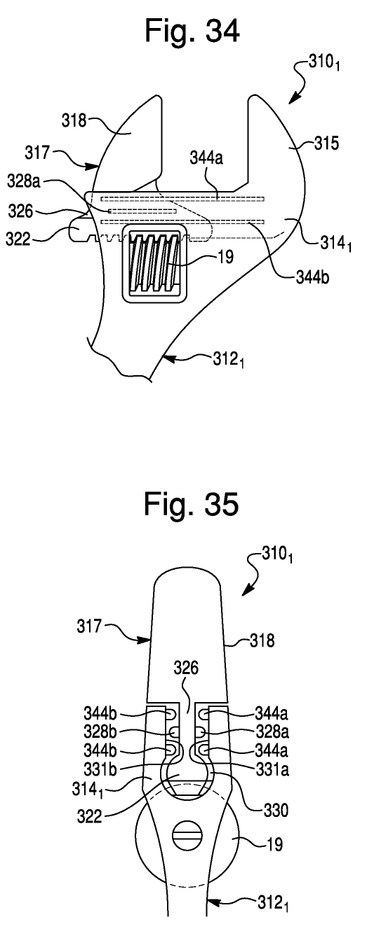

According to the alternative embodiment of the adjustable wrench of the present invention generally depicted by the reference character 310₁ and illustrated in FIGS. 34 and 35, the bearing guide device of the present invention includes two traverse bearing guides 328a and 328b integrally formed on opposite sides of a neck portion 326 of a moveable jaw member 317 and extending in the direction of the drive axis A, and two pairs of traverse bearing guides 344a and 344b located inside a traverse mounting slot 330 of a wrench head portion 214 and formed integrally with opposite side walls of the mounting slot 330 as shown in FIG. 33. Preferably, as illustrated in FIGS. 34 and 35, each of the traverse bearing guides 328a and 328b of the moveable jaw member 317 is in the form of a raised boss formed as a domed shaped longitudinal rib running along the length of the reduced neck portion 326 of the moveable jaw member 317, and whereas, each of the traverse bearing guides 344a and 344b of the wrench head portion 314 is a raised boss formed as a domed shaped longitudinal ribs running parallel along the length and arranged laterally inside of the mounting slot 330 in the wrench head portion 314₁.

When the moveable jaw member 317 is installed in the wrench head portion 314, as shown in FIG. 35, the traverse bearing guides 344a and 344b of the wrench head portion 314, act as guides and stops that straddle the traverse bearing guides 328a and 328b of the moveable jaw member 317. As the moveable jaw member 317 traverses inside the mounting slot 330 of the wrench head portion 314, the traverse bearing guides 328a and 328b of moveable jaw member 317 bump and slide between the straddling traverse bearing guides 344a and 344b located in the mounting slot 330. The traverse bearing guides 344a and 344b of the wrench head portion 314, further act as stops that contain and secure the moveable jaw member 317 from pulling out of the wrench head portion 314, and also prevent the moveable jaw member 317 from rocking back and fourth in the mounting slot 330 of the wrench head portion 314, in the direction away from the stationary jaw 315.

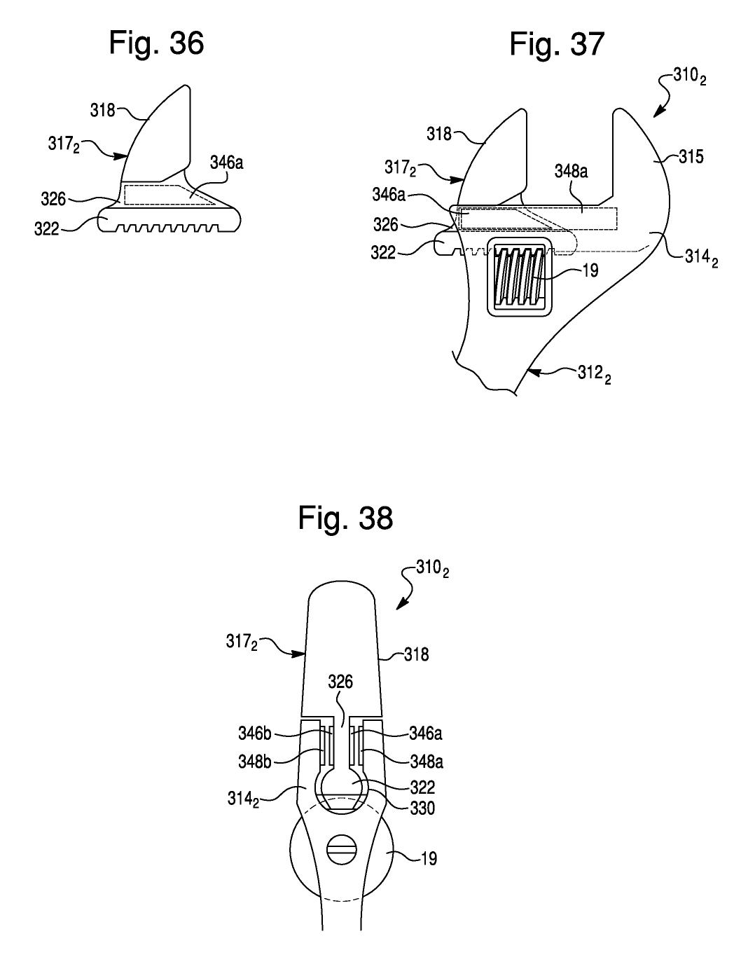

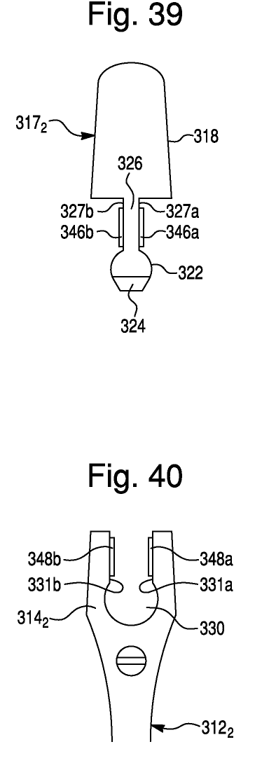

According to the further alternative embodiment of the powered adjustable wrench of the present invention generally depicted by the reference character 3102 and illustrated in FIGS. 36-40, the bearing guide device includes two traverse bearing guides 346a and 346b arranged on opposite sides of a neck portion 326 of a moveable jaw member 317₂ and extending in the direction of the drive axis A, and two traverse bearing guides 348a and 348b disposed inside a traverse mounting slot 330 of a wrench head portion 314₂. As illustrated in FIGS. 37 and 38, the traverse bearing guides 346a and 346b of the moveable jaw member 317₂ are arranged to be in sliding contact with the traverse bearing guides 348a and 348b of the wrench head portion 314₂. Preferably, the traverse bearing guides 346a, 346b and 348a, 348b, as shown in detail in FIGS. 38-40, are in the form of raised bosses formed as longitudinal prismatic ribs extending along the drive axis A of the wrench head portion 314₂. As further shown in FIGS. 38 and 40, the traverse bearing guides 348a and 348b extend inwardly (toward each other) from the opposite side walls 331a and 331b, respectively, of the mounting slot 330 in the direction substantially perpendicular, or transverse, to the drive axis A, while the traverse bearing guides 346a and 346b extend outwardly (away from each other) from opposite side walls 327a and 327b, respectively, of the neck portion 326 of the moveable jaw member 317₂ in the direction substantially perpendicular, or transverse, to the drive axis A.

Further preferably, each of the traverse bearing guides 346a, 346b and 348a, 348b is a strip of Teflon impregnated self-adhesive silicone tape affixed to the metal of the neck portion 326 of the moveable jaw member 317₂ (bearing guides 346a and 346b) or to the side walls 331a and 331b of the mounting slot 330. When the moveable jaw member 317₂ is installed into the wrench head portion 314₂ as shown in FIG. 38, the moveable jaw member 317₂ traverses inside of the mounting slot 330 of the wrench head portion 314₂, and whereas the bearing guides 346a and 346b of the moveable jaw member 317₂ slide over the bearing guides 348a and 348b located in the mounting slot 330 in the wrench head portion 314₂, thus eliminating metal-to-metal contact between the moveable jaw member 317₂ and the wrench head portion 314₂ at this area (i.e. inside the mounting slot 330). Contact between the Teflon impregnated strips dramatically reduces friction and noise between the two members. The thickness of the Teflon strips makes up for the gap clearances and corrects the leaning problem of the moveable jaw member 317₂. The “slickness” of the Teflon strips increases the speed of the moveable jaw member 317₂ and improves the number of traverse cycles and efficiency of the power source.

Therefore, the adjustable wrench in accordance with the present invention is a novel arrangement of the adjustable wrench including a weight reduced moveable jaw member and/or wrench head portion, and traverse bearing guides added to replace dimensional gap clearances between the contacting points of the moveable jaw member and the mounting slot of the wrench head portion. By reducing the weight of the moveable jaw member the motor, drive train and batteries of the powered adjustable wrench have less strain on them and do not have to work as hard to provide the reciprocating movement. Thus, reducing weight of the moveable jaw member and strategically adding traverse bearing guides to the appropriate areas of the reciprocating movement directly relates to better efficiency of the overall performance of the adjustable wrench of the present invention. The traverse bearing guides replace the dimensional gap clearances between the two members and eliminate metal-to-metal contact, thus reducing noise and friction and providing a self lubricating surface that increases the speed of the moveable jaw member and improves efficiency of the power source.

The foregoing description of the preferred embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. An adjustable wrench comprising:
a wrench body including a wrench body member having a handle portion and a head portion, said head portion defining a stationary jaw and a mounting slot in said head portion, said mounting slot having opposite first and second side walls extending in the direction of a transverse axis of said head portion and spaced from each other in the direction of a cross axis of said head portion perpendicular to said transverse axis thereof;
a movable jaw member mounted to said head portion of said body member for reciprocating movement along said transverse axis of said head portion, said movable jaw member including a movable jaw in alignment with said stationary jaw and a gear rack having a toothed segment, said gear rack being slidably mounted in said mounting slot; and
a bearing guide device disposed in said mounting slot and including at least two bearing guides disposed in a space between said gear rack and said mounting slot so that at least one of said at least two bearing guides being arranged on one side of said gear rack and at least one of said at least two bearing guides being arranged on the opposite side of said gear rack;
said bearing guides replacing a dimensional gap clearance defined by said space between said gear rack and said mounting slot for centering and guiding said gear rack in said mounting slot.

2. The adjustable wrench as defined in claim 1, wherein said gear rack of said movable jaw member has opposite first and second side walls extending in the direction of said transverse axis of said head portion.

3. The adjustable wrench as defined in claim 2, wherein one of said bearing guides is provided on one of said first side wall of said gear rack and said first side wall of said mounting slot, and another of said bearing guides is provided on one of said second side wall of said gear rack and said second side wall of said mounting slot.

4. The adjustable wrench as defined in claim 3, wherein one of said bearing guides is integrally formed on one of said first side wall of said gear rack and said first side wall of said mounting slot, and another of said bearing guides is integrally formed on one of said second side wall of said gear rack and said second side wall of said mounting slot.

5. The adjustable wrench as defined in claim 3, wherein said bearing guides are in the form of strips impregnated with fluoropolymer and adhesively bonded to one of said gear rack and said mounting slot.

6. The adjustable wrench as defined in claim 1, wherein said gear rack includes a gear rack portion having said toothed segment and a neck portion interconnecting said movable jaw with said gear rack portion;
wherein said gear rack portion has opposite first and second side walls extending in the direction of said transverse axis of said head portion; and
wherein said neck portion has opposite first and second side walls extending in the direction of said transverse axis of said head portion.

7. The adjustable wrench as defined in claim 6, wherein one of said bearing guides is provided on said first side wall of said gear rack portion of said gear rack and another of said bearing guides is provided on said second side wall of said gear rack portion of said gear rack.

8. The adjustable wrench as defined in claim 7, wherein one of said bearing guides is integrally formed on said first side wall of said gear rack portion of said gear rack and another of said bearing guides is integrally formed on said second side wall of said gear rack portion of said gear rack.

9. The adjustable wrench as defined in claim 6, wherein at least one of said bearing guides is provided on said first side wall of said neck portion of said gear rack and at least of said bearing guides is provided on said second side wall of said neck portion of said gear rack.

10. The adjustable wrench as defined in claim 9, wherein one of said bearing guides is integrally formed on said first side wall of said neck portion of said gear rack and another of said bearing guides is integrally formed on said second side wall of said neck portion of said gear rack.

11. The adjustable wrench as defined in claim 9, wherein said bearing guides are in the form of strips impregnated with fluoropolymer and adhesively bonded to said neck portion of said gear rack.

12. The adjustable wrench as defined in claim 6, wherein said bearing guide device includes at least four bearing guides so that at least two of said bearing guides are arranged on said first side wall of said neck portion of said gear rack and at least two of said bearing guides are arranged on said second side wall of thereof; said at least two of said bearing guides arranged on the same side of said neck portion are offset from each other in the direction of a longitudinal axis of said head portion of said wrench body member;
wherein said longitudinal axis of said head portion is perpendicular to both said transverse axis and said cross axis thereof.

13. The adjustable wrench as defined in claim 6, wherein said bearing guide device includes at least four bearing guides so that at least two of said bearing guides are arranged on said first side wall of said mounting slot and at least two of said bearing guides are arranged on said second side wall of said mounting slot; said at least two of said bearing guides arranged on the same side of said mounting slot are offset from each other in the direction of a longitudinal axis of said head portion of said wrench body member;
wherein said longitudinal axis of said head portion is perpendicular to both said transverse axis and said cross axis thereof.

14. The adjustable wrench as defined in claim 6, wherein said bearing guide device includes at least four bearing guides so that at least two of said bearing guides are provided on said opposite first and second side walls of said mounting slot and at least two of said bearing guides are provided on said opposite first and second side walls of said neck portion of said gear rack;
wherein said bearing guides provided on said neck portion of said gear rack are offset from said bearing guides provided on said mounting slot in the direction of a longitudinal axis of said head portion of said wrench body member;
wherein said longitudinal axis of said head portion is perpendicular to both said transverse axis and said cross axis thereof.

15. The adjustable wrench as defined in claim 6, wherein said bearing guide device includes two bearing guides bearing guides provided on opposite first and second side walls of said neck portion of said gear rack and two bearing guides provided on said opposite first and second side walls of said mounting slot so that said bearing guides disposed on said neck portion of said gear rack are in alignment with said bearing guides disposed on said mounting slot and are in sliding contact with each other.

16. The adjustable wrench as defined in claim 1, further comprising a drive mechanism mounted to said head portion of said body member, said drive mechanism being operably connected to said movable jaw member for selectively moving said movable jaw in directions away from and toward said stationary jaw, said drive mechanism including a worm gear rotatably mounted in said head portion of said body member, said worm gear having a screw thread drivingly engaging teeth of said toothed segment of said gear rack portion of said movable jaw.
